(19) United States
(12) Patent Application Publication
(10) Pub. No.: US 2023/0244518 A1
(43) Pub. Date: Aug. 3, 2023

(54) ISOLATED ARENA ENVIRONMENT INSTANTIATION FOR ASYNCHRONOUS CONTENT DELIVERY

(71) Applicant: ThriveDX Digital Skills Training Ltd., Ramat Gan (IL)

(72) Inventors: Ilan Mindel, Giv'at Shmuel (IL); Asaf N. Katz, Herzliya (IL); Bonnie Tabibian, Bat Yam (IL); Igor N. Semyonov, Holon (IL); Stav Shisha, Givatayim (IL)

(73) Assignee: ThriveDX Digital Skills Training Ltd., Ramat Gan (IL)

(21) Appl. No.: 18/163,118

(22) Filed: Feb. 1, 2023

Related U.S. Application Data
(60) Provisional application No. 63/305,630, filed on Feb. 1, 2022.

(51) Int. Cl. G06F 9/455

(52) U.S. Cl. CPC G06F 9/45558; G06F 2009/45562; G06F 2009/4557

(57) ABSTRACT

Certain embodiments of the present disclosure relate to a system and method for streaming synchronous content on a first interface of a user device of a plurality of user devices. Further, the system or method may include designing a virtual resource container running model for the container management engine in response to the received selection. Also, the system or method may include creating a virtual machine instance based on the received selection. Moreover, the system or method may include analyzing the selection received on an interface of the virtual machine instance using a plurality of checkers. Further, the system or method may include generating an output, using the machine learning algorithms, based on a match of the selection received with the set of results, where the output may include a result value and a set of instructions to be performed on the virtual machine instance.

This application is a non-provisional of and claims priority to Provisional Application Ser. No. 63/305,630, filed Feb. 1, 2022, which is incorporated herein by reference for all purposes.

### BACKGROUND

Conventional systems rely on simulations and not real-live scenarios. Interaction with those simulations do not approach the dynamism of actual systems. This disclosure relates in general to the field of containerization and specifically, to the generation of real-life scenarios rather than simulations.

### SUMMARY

The ensuing description provides preferred exemplary embodiment(s) only, and is not intended to limit the scope, applicability, or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

In one embodiment, the present disclosure addresses the existing limitations by providing a system for generating asynchronous content associated with a docker container. The system includes a docker container and an asynchronous content generator that runs within the container. Also, the present disclosure provides several advantages, including improved performance and scalability of the container system, as well as the ability to easily manage and access asynchronous content.

In one embodiment, the present disclosure provides a method for a web portal for a interactive process (e.g. learning process) in a computing task running environment. An interface of a virtual machine instance (e.g. learning management interface) is viewed on a user device of the plurality of user devices. Synchronous content is streamed on the interface of the virtual machine instance of the user device. The synchronous content includes a set of interactive queries accessible on the plurality of user devices. A selection of an interactive program of the interactive process is received from the interface of the virtual machine instance.

In yet another embodiment of the present disclosure, a plurality of virtual machine instances are provided hosted in the cloud for access to the computing task running environment on the user device. Subsets of the plurality of user devices are separated using a plurality of domains for a plurality of tenants. The plurality of virtual machine instances is hosted on a cloud environment to enable the user device to access the computing task running environment. The computing task running environment is user specific and/or tenant specific. The computing task running environment includes an interactive program of the interactive process delivered using an interface of the user device. The interactive program includes interactive queries comprising predetermined steps queries.

In yet another embodiment of the present disclosure, asynchronous content is streamed via the computing task running environment on the interface of the user device. The asynchronous content includes user specific interactive queries accessible on the user device. User input is received with respect to the interactive program from the interface run on a virtual machine instance of the plurality of virtual machine instances. An output is generated based on an analysis of the user input. The output is communicated to the user device on the interface.

In another embodiment, the present disclosure provides a method for analyzing a functional test on a computing task running environment. A virtual machine instance is used to facilitate a user device of a plurality of user devices that are within a plurality of tenants to access the computing task running environment. The computing task running environment is user specific and/or tenant specific. The computing task running environment presents a functional test to be performed on the user device. The functional test includes interactive queries comprising predetermined steps queries.

In yet another embodiment of the present disclosure, a user input is received with respect to the functional test from an interface of the user device. The user input is analyzed to generate an output of the functional test. The output is generated based on the analysis. The output includes a plurality of instructions for the user device. The plurality of instructions are performed on the virtual machine instance. The output is communicated to the user device via the interface.

In yet another embodiment, the present disclosure provides a method of instantiating a plurality of virtual machine harbors for a computing task running environment of an interactive process. A package of a plurality of packages is parsed. Each package of the plurality of packages specifies a virtual machine harbor and applications running thereon. The package defines a configuration of the computing task running environment. The computing task running environment is user specific and tenant specific. The computing task running environment includes a test of the interactive process for the user device. The test includes labs, predetermined steps queries. An application is loaded on the user device to access the computing task running environment and to undertake a test of the interactive process. A user input corresponding to the test is received. An output of the test is generated by analyzing the user input. The output of the test is communicated to the user device via an interface.

A system of a plurality of computers can be configured to perform particular operations or actions by virtue of having software, firmware, hardware, or a combination of them installed on the system that in operation causes or cause the system to perform the actions. A plurality of computer programs can be configured to perform particular operations or actions by virtue of including instructions that, when executed by data processing apparatus, cause the apparatus to perform the actions.

In one general aspect, method may include selecting a container management engine as a computing task running environment. Method may also include streaming synchronous content on a first interface of a user device of a plurality of user devices, where the synchronous content includes a set of interactive queries accessible on the plurality of user devices. Method may furthermore include receiving a selection of an interactive program from the first interface based on the synchronous content. Method may in addition include designing a virtual resource container running model for the container management engine in response to the received selection.

In yet another embodiment of the present disclosure, the method may moreover include creating a virtual machine instance based on the received selection, where the received selection may include selection of at least one interactive program. Method may furthermore include the virtual machine instance includes a plurality of harbors. Method may in addition include each harbor includes a plurality of containers, a harbor agent, a plurality of skippers and a plurality of checkers. Method may moreover include analyzing the selection received on an interface of the virtual machine instance using a plurality of checkers.

In yet another embodiment of the present disclosure, the method may also include where the checkers are adapted to compare the selection received with a set of results stored within each harbor of the plurality of harbors using machine learning algorithms. Method may furthermore include generating an output, using the machine learning algorithms, based on a match of the selection received with the set of results, where the output may include a result value and a set of instructions to be performed on the virtual machine instance.

Other embodiments of this aspect include corresponding computer systems, apparatus, and computer programs recorded on one or more computer storage devices, each configured to perform the actions of the methods.

In yet another embodiment of the present disclosure, the container management engine is configured to create the virtual machine instance for each end user using images of instances of virtual machines. Method where the virtual machine instance is hosted on cloud environment and where each harbor includes a plurality of docker containers hosted on the cloud environment. The method may include determining the interactive program, via a plurality of harbors, based on a plurality of attributes associated with the user device, where the plurality of attributes includes a level of skills, user requirements, and/or educational background of an end user associated with the user device.

In yet another embodiment of the present disclosure, the method providing communication between the plurality of harbors and the user device via the harbor agent, receiving testing inputs on the user device using the harbor agent and providing the received selection from the user device to the harbor for processing via the container management engine. The method may include: identifying an anomaly in the harbor based on periodically receiving a status check response from the plurality of skippers, and providing the identified anomaly to the container management engine for rectification.

In yet another embodiment of the present disclosure, the method may include generating asynchronous content based on user profile associated with the user device and performance associated with the user device. Implementations of the described techniques may include hardware, a method or process, or a computer tangible medium.

In one general aspect, system may include a container management engine as a computing task running environment, where the container management engine is configured to stream synchronous content on a first interface of an user device of a plurality of user devices, where the synchronous content includes a set of interactive queries accessible on the plurality of user devices. System may furthermore include receive a selection of an interactive program from the first interface based on the streamed synchronous content. System may in addition include a virtual resource container running model for the container management engine in response to the received selection.

In yet another embodiment of the present disclosure, the system may moreover include create a virtual machine instance based on the received selection, where:. System may also include the received selection may include selection of at least one interactive program. System may furthermore include the virtual machine instance includes a plurality of harbors. System may in addition include each harbor includes a plurality of containers, a harbor agent, a plurality of skippers and a plurality of checkers. System may moreover include analyze the selection received on an interface of the virtual machine instance using a plurality of checkers.

In yet another embodiment of the present disclosure, the system may also include where the checkers are adapted to compare the selection received with a set of results stored within each harbor of the plurality of harbors using machine learning algorithms. System may furthermore include generate an output, using the machine learning algorithms, based on a match of the selection received with the set of results, where the output may include a result value and a set of instructions to be performed on the virtual machine instance. Other embodiments of this aspect include corresponding computer systems, apparatus, and computer programs recorded on one or more computer storage devices, each configured to perform the actions of the methods.

In yet another embodiment of the present disclosure, the container management engine is further configured to create the virtual machine instance for each end user using images of instances of virtual machines. System where the virtual machine instance is hosted on cloud environment and where each harbor includes a plurality of docker containers hosted on the cloud environment.

In yet another embodiment of the present disclosure, the container management engine is further configured to determine the interactive program, via a plurality of harbors, based on a plurality of attributes associated with the user device, where the plurality of attributes includes a level of skills, user requirements, and/or educational background of an end user associated with the user device.

In yet another embodiment of the present disclosure, the system where the container management engine is further configured to: provide communication between the plurality of harbors and the user device via the harbor agent, test inputs received on the user device using the harbor agent, and provide the received selection from the user device to the harbor for processing via the container management engine. System where the container management engine is further configured to: identify an anomaly in the harbor based on periodically receiving a status check response from the plurality of skippers, and provide the identified anomaly to the container management engine for rectification.

In yet another embodiment of the present disclosure, the container management engine is further configured to generate asynchronous content based on an user profile associated with the user device and performance associated with the user device. Implementations of the described techniques may include hardware, a method or process, or a computer tangible medium.

In one general aspect, computer-readable storage medium may include selecting a container management engine as a computing task running environment. Computer-readable storage medium may also include streaming synchronous content on a first interface of an user device of a plurality of user devices, where the synchronous content includes a set of interactive queries accessible on the plurality of user devices. Medium may furthermore include receiving a selection of an interactive program from the first interface based on the synchronous content. Medium may in addition include designing a virtual resource container running model for the container management engine in response to the received selection.

Further areas of applicability of the present disclosure will become apparent from the detailed description provided hereinafter. It should be understood that the detailed description and specific examples while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures:

FIG. 1 illustrates a block diagram of an embodiment of an interactive management system;

FIG. 2 illustrates a communication diagram of an embodiment of an interactive management system;

FIG. 3 illustrates a block diagram of an embodiment of a virtual machine instance;

FIG. 4 illustrates an embodiment of an interactive module;

FIG. 5 illustrates an exemplary embodiment of the interactive program presented to the end-user on the end-user device;

FIG. 6 illustrates a Graphical User Interface (GUI) of a practice arena 612 in the computing task running environment 102 presented on the interface 106 of the end user 202

FIG. 7 illustrates a flowchart of an embodiment of an interactive process in the computing task running environment;

FIG. 8 illustrates a flowchart of an embodiment of a checking process of a functional test performed; and

FIG. 9 illustrates a flowchart of an embodiment of an installation process 900 for instantiating harbors for a computing task running environment.

In the appended figures, similar components and/or features may have the same reference label. Further, various components of the same type may be distinguished by following the reference label with a second alphabetical label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

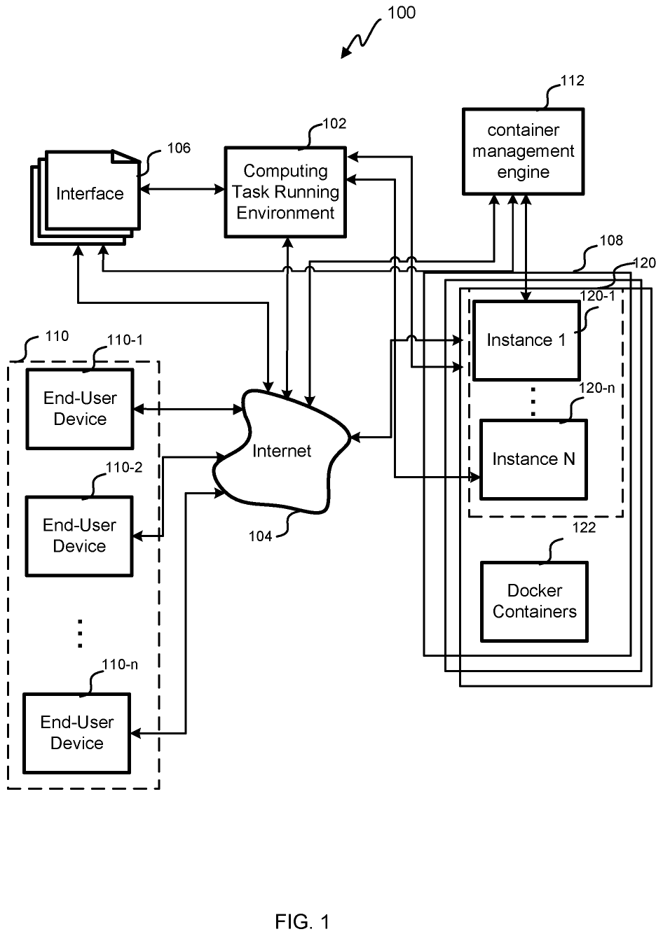

Referring first to FIG. 1, a block diagram of an embodiment of an interactive management system 100 that provides automated interactive queries to users via an online web portal is shown. The interactive management system 100 includes a computing task running environment 102, a public internet 104, an interface 106, servers 108, end-user device(s) 110 (including end-user devices 110-1, 110-2, 110-n), and a container management engine 112. The interactive management system 100 allows multiple-tenants in different domains to communicate with the web portal over the public internet 104. The interactive management system 100 allows multiple tenants or enterprises to all use the same network separated by domain or some other logical separation. Encryption, leased, encrypted tunnels, firewalls, and gateways can be used to keep the data from one tenant separate from other tenants. Each end-user of the end-user devices 110-1, 110-2, 110-n communicates with the interface 106 of the web portal of the interactive management system 100 to access the interactive queries using the public internet 104. Interface 106 hosts a web page and/or Graphical User Interface (GUI) through which the end user devices 110-1, 110-2, and 110-n interact with the interactive management system 100. Interface 106 is a front-end application running on a user's browser that communicates with a web server which is the computing task running environment 102 The end-user device(s) 110 are connected with the computing task running environment 102, which, in turn, communicates with the container management engine 112 using the public internet 104.

The container management engine 112 provides multi-tenancy control for each domain. Server 108 includes docker containers 122, and virtual machine instances 120 (including virtual machine instances 120-1, 120-2, 120-n). The virtual machine instances 120-1, 120-2, and 120-n are supported to run software environments. Any operating system running in a virtual machine on a physical device is supported to allow any enterprise to have their software environments running in a more secure, more controlled, and potentially higher performance instantiations. The servers 108 include virtualization software and other types of hardware and/or software entities that create a computing platform upon which instances 120 may be run.

The computing task running environment 102 is configured to allow an end user of the end user device 110 to access at least a portion of the interactive queries for viewing, learning, analysis, and/or reporting. In an embodiment, the computing task running environment 102 is provided for tracking the end user's progress as the end user undertakes the interactive queries.

The computing task running environment 102 provides the interactive queries by enabling the transmission of personalized user-specific interactive queries that are designed for each end user based on his/her profile, attributes, or preferences. The computing task running environment 102 functions in parallel with the container management engine 112. Interface 106 is the front-end application that communicates with the web server computing task running environment 102 of the interactive management system 100. The computing task running environment 102 provides synchronous content that is the common content including interactive queries for all the end users.

The container management engine 112 is configured to create virtual machine instance(s) 120 for each end-user using images of instances of virtual machines. The virtual machine instance(s) 120 provides a computing task running environment for the end user. The computing task running environment is user specific and provides an option for a personalized interface and interactive queries for the end user.

The container management engine 112 is a backend server for the computing task running environment 102. The container management engine 112 provides asynchronous content including user specific arena environment for interactive queries. The interactive management system 100 keeps each end user isolated from other end users and includes specific interactive queries for the end user based on user requirements and expertise. Various orchestration strategies or virtualization technologies are used to create the computing task running environment that is the environment for end users, for example, students. Orchestration strategies include Elastic Container Service Elastic Compute Cloud (ECSEC2/ECSFargate), EC2.

The virtual machine instances 120 are created for each interactive queries that the end user enrolls in. The virtual machine instances 120 runs on the cloud environment of the interactive management system 100. For example, the end user enrolls in interactive queries which includes a package of content, for example, 5 lessons and further includes three labs, each lab including two predetermined steps queries. When a lab is accessed, an isolated instance is created for it, for a limited time frame. This is done upon access. The harbors are created on access. A lab is an entity, and a challenge is an entity.

The implementation is abstracted as a harbor. The lab is a Harbor. Challenge is a Harbor. Each harbor may contain a plurality of virtual machines 120 hosted on the cloud, a plurality of docker containers 122 hosted on the cloud, and a combination of docker containers 122 and virtual machines 120 hosted on the cloud. Some examples of the cloud vendors providing virtual machine services include Amazon Web Services (AWS)®, Google Cloud Platform (GCP)®, and Microsoft Azure®. The cloud providers may be provided with some captive to a particular enterprise or otherwise not accessible to multiple domains.

The computing task running environment 102 is an application for the administration, documentation, tracking, reporting, and delivery of content, interactive programs, and development programs. However, computing tasks running environment 102 can be affected by external factors, such as changes in the operating system or other applications running on the host machine, which can lead to instability or even system failure. To overcome such existing problems, docker technology provides an effective solution for isolating the environment for the computing task running environment 102 by creating docker containers 122 for the system.

In another embodiment, the present disclosure provides a method and system for isolating the environment for the computing task running environment 102 via the container management engine 112. Also, the container management engine 112 utilizes the docker technology to create docker containers 122 for the computing task running environment 102.

Furthermore, the container management engine 112 is further configured to create, configure and command the docker containers 122 based on the user profiles or inputs received from at least one end-user device 110. The container management engine 112 is configured to act as a bridge between the end user devices 110 and the docker containers 122, ensuring smooth and secure communication between the end user devices 110 and the docker containers 122.

In yet another embodiment, the system includes the end user devices 110, docker containers 122, and the container management engine 112. Moreover, the container management engine 112 is configured to create, manage, and run the docker containers 122.

In yet another embodiment, the container management engine 112 is also responsible for maintaining a main configuration file that at least one end-user device 110 can use to command and control the docker containers 122 via computing task running environment 102.

In yet another embodiment, the container management engine 112 is adapted to parse multiple requests from different end-user devices 110 simultaneously. Also, the container management engine 112 is further adapted to configure and command the docker containers 122 based on the requests received from the end-user device(s) 110. Furthermore, the container management engine 112 is also adapted to handle the scaling of the system based on the number of end-user device(s) 110 and their usage patterns.

Moreover, the containerization of the computing task running environment 102 also allows for easy deployment and scaling of the system. The computing task running environment 102 can be easily moved between different operating system environments without any issues. Additionally, the system is also secure as it isolates the computing task running environment 102 from the end user devices and external factors.

In yet another embodiment, the present disclosure relates to a method and system for isolating the environment for the computing task running environment 102 using docker technology using the container management engine 112. The system utilizes the docker technology to create the docker containers 122 for the computing task running environment 102. Additionally, the container management engine 112 is further configured to create and command the docker containers 122.

In yet another embodiment, the method for isolating the environment for computing tasks running environment 102 using docker containers 122 is disclosed. The system includes the container management engine 112 that acts as a provisioning software and is located between the communication layer (e.g. web browser or mobile application) associated with the end-user device 110 and the docker containers 122.

Additionally, the container management engine 112 is used to configure the dockers containers 122 and also includes a main configuration file. The container management engine 112 can use the main configuration file to command and control the docker containers 122.

In yet another embodiment, the container management engine 112 is responsible for configuring the dockers containers 122 to create an isolated environment for end user device 110. This is accomplished by using the main configuration file to specify the appropriate settings for each docker container 122, such as the amount of memory and CPU resources to be allocated, and the software packages that are to be installed.

In yet another embodiment, once the dockers containers 122 are configured, the container management engine 112 can use the main configuration file to command and control the docker containers. For example, the container management engine 112 can start and stop the dockers, as well as monitor their status and resource usage.

The container management engine 112 can also use the main configuration file to update the software packages installed in the dockers, or to apply security patches. In this way, the disclosed system provides a flexible and secure way to isolate the environment for the computing task running environment 102 by using the dockers technology. Moreover, this allows end-user devices 110 to access the computing task running environment 102 in a safe and secure environment, with minimal risk of interference or conflicts with other end-user devices 110.

In yet another embodiment, the method discloses instantiating a computing task running environment for asynchronous content delivery using docker containers. Further, the method utilizes a virtual computing resource model based on docker container technology, which improves the operation efficiency of a network by allowing the edge server to concurrently process a plurality of computing tasks.

In yet another embodiment, the method further addresses the limitations of traditional frameworks for executing computing tasks, which either lack proper data and resource isolation or consume excessive resources. Also, the method utilizes a container, which has the same isolation capacity as a virtual machine but occupies less space, consumes fewer resources for maintenance, and has a faster starting speed.

In yet another embodiment, the method selects a container management engine (Docker) as the computing task running environment and designs a virtual resource container running model in an edge server for the container management engine (Docker).

Furthermore, each edge server comprises a plurality of containers, and each container processes one computing task, thus providing a safe and efficient way of performing service migration and fine-grained division service migration.

In yet another embodiment, the method includes using a virtual computing resource model based on docker container technology on an edge server. The edge server is able to concurrently process a plurality of computing tasks from various terminal devices but has limitations in the types of services it can carry. To address this, a framework for service migration is implemented using docker container technology, which allows for flexible and safe processing of various services while also addressing concurrency of computing tasks based on docker container technology on an edge server.

Additionally, the edge server is able to concurrently process a plurality of computing tasks from various terminal devices but has limitations in the types of services it can carry. To address this, a framework for service migration is implemented using docker container technology, which allows for flexible and safe processing of various services while also addressing concurrency of computing tasks based on docker container technology on an edge server.

In yet another embodiment, the docker containers provide an isolation capacity similar to virtual machines, but with less resource consumption and faster start-up speeds. Furthermore, the method also utilizes a management engine (docker) as the computing task running environment and designs a virtual resource container running model on the edge server, in which each edge server comprises a plurality of containers, and each container processes one computing task. This allows for fine-grained division of service migration and virtualization of computing resources on the edge server.

A plurality of enterprises (not shown) may also communicate with the public Internet 104 and the end user devices 110 of their domain. Some examples of enterprises may include corporations, educational facilities, governmental entities, and private consumers. Each enterprise may support a plurality of domains to logically separate its networks. The end user devices 110 for each domain may include individual computers, tablets, servers, handhelds, and network infrastructure that are authorized to use the computing resources of their respective enterprise.

Another virtual machine is added to the virtual machine instances 120 and exposes a control interface over the internet 104 to the end user device 110. The end user can control an operating system using his browser.

The applications are in communication with the end user devices 110. The applications are part of the computing task running environment. Some of the applications are actually isolated environment, and some of them are mere interfaces meant to provide the end user with means to communicate with the isolated environment. The applications run on virtual machines hosted on servers 108.

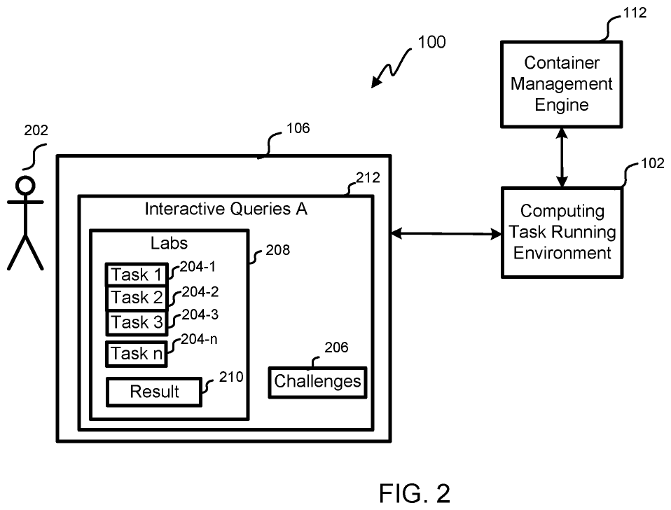

Referring next to FIG. 2, a communication diagram of an embodiment of an interactive management system 100 that provides interactive engagement to end users of end-user devices 110 via the interface 106 is shown. Interface 106 is accessed by using a web browser. The interactive management system 100 provides a number of interactive queries to end-user 202 of the end-user device 110 via the interface 106. The end user 202 uses interface 106 on the end user device 110 to access a computing task running environment that includes the interactive queries. Each isolated environment is a lab or a challenge. The interactive queries may contain predetermined steps queries.

The selection screen of FIG. 2 is used to select a lab 208, then communication with the container management engine 112 is established. It spawns lab 208, the interface switches to the lab-practice page in which an instance is presented on interface 106. The computing task running environment is deployed using the virtual machine instances 120 by the container management engine 112 and is provided to interface 106.

The computing task running environment 102 processes the display and selection of the interactive queries that are generally available to all the end users. The container management engine 112 handles the user specific interactive queries and content. The computing task running environment 102 authenticates the end user 202. The computing task running environment 102 presents an authentication screen to the end user 202 and may provide a list of questions or checklists to the end user 202 for verification.

After the end user 202 is authenticated, the computing task running environment 102 retrieves a profile for the end user 202. The computing task running environment 102 displays synchronous content to the end user 202 via interface 106. For example, the synchronous content may include practice arena options, interactive queries, and predetermined steps queries.

Interface 106 presents the interactive queries to the end user 202. Interface 106 receives an input from the end user 202 via an input device connected with the end user device 110. The input device may include, for example, a keyboard, or mouse, to select a plurality of interactive queries. The end user device 110 may also include a touchscreen for receiving the input of the end user 202. Based on a selection of a plurality of interactive queries provided through the computing task running environment 102, interface 106 changes and presents the selected plurality of interactive queries to the end user 202.

The interactive queries include predetermined steps queries (e.g. lessons, challenges, topics, labs). Interface 106 presents the interactive queries to the end user 202. The interactive queries contain the labs/challenges which are the ones that reside in the computing task running environment. For example, the end user 202 selects interactive queries A 212 from the interactive queries provided on the computing task running environment 102.

Interface 106 is configured to display the selected interactive queries A 212 to the end user 202 using a display device for example, a monitor, display screens, projectors, or other types of visual display devices connected with the end user device 110. The interactive queries A 212 includes predetermined steps queries 204-1, 204-2, 204-3, 204-n, challenges 206, labs 208, and a result 210. The predetermined steps query 204-1, 204-2, 204-3, and 204-n are contained within labs 208.

The end user 202 undertakes the predetermined steps queries 204-1, 204-2, 204-3, 204-n, the challenges 206, and the labs 208 and provides test inputs which are part of labs and challenges, using a user interface of the computing task running environment to the container management engine 112 while undergoing each of them. The container management engine 112 processes the test results in the respective virtual machine instances 120.

After the virtual machine instances 120 processes the input, an output is generated which is further provided to interface 106 via the container management engine 112. The output may be a success or failure. In case of failure, the end user 202 is provided with a series of steps towards achieving success, for example, write command ABC before command XYZ to complete step K. On performing the steps by the end user 202, the output changes to success.

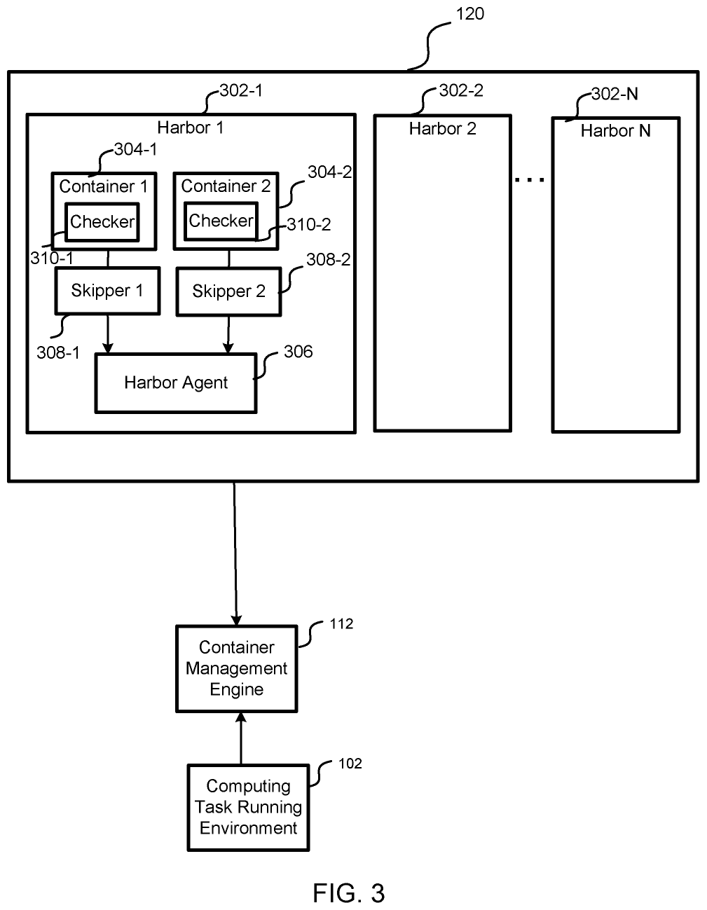

Referring next to FIG. 3, a block diagram of an embodiment of a virtual machine instance 120 is shown. The virtual machine instances 120 includes a plurality of harbors 302 including harbors 302-1, 302-2, 302-N, each harbor 302-1, 302-2, 302-N includes a plurality of containers including containers 304-1, 304-2, a harbor agent 306, and a plurality of skippers 308 including skippers 308-1, 308-2 and a plurality of checkers 310 including checkers 310-1, 310-2. Skipper 308 is a software that runs within container 304 alongside an application deployed on container 304.

The plurality of harbors 302 includes containers 304-1, and 304-2 of the virtual machine instance 120. The plurality of harbors 302 may be a database, a web server or a file transfer server among other similar components. The containers 304 within harbor 302 may be a database/web server/FTP server or other software. Harbors 302 contains these applications. The plurality of harbors 302 is used in the creation of the computing task running environment for the end users 202. Every isolated environment is a single harbor. The plurality is all of the environments for all of the users.

The end user 202 performs a task in a interactive queries on the computing task running environment using interface 106. The plurality of harbors 302 determines the interactive queries based on the attribute, skills, user requirements, and/or educational background of the end user 202. The interactive queries includes a series of lessons that may further include predetermined steps queries. The predetermined steps queries are contained within the labs. Challenges, quizzes, or labs are successfully undertaken in order to complete the interactive queries. The end user 202 provides a user input corresponding to the task from interface 106. The user input is provided to the container management engine 112 for processing.

The harbor agent 306 is a managing agent that provides communication between the plurality of harbors 302-1, 302-1, 302-N, and the end user device 110. The harbor agent is contained within a harbor 302-1 and extends the harbor 302-1 with the capability of testing user inputs within the isolated environment (i.e. the harbor 302-1). The harbor agent 306 provides the user input for the task received from the end user device 110 to the harbor 302-1 for processing via the container management engine 112.

The harbor agent 306 also provides the user input to the checkers 310-1, and 310-2 for analysis. The harbor agent 306 receives a status check from the skippers 308-1, and 308-2 to identify any anomaly in the harbor 302-1 and indicate the anomaly to the container management engine 112 so that it can be rectified. A harbor 302-1 is a collection of containers 304-1, 304-2, and virtual machines 120. The containers 304-1, 304-2 have their own skippers 308-1, 308-2, and communication with a specific container 304-1 or container 304-2 initiates when the container management engine 112 communicates to the harbor agent 306. The harbor agent 306 communicates with the specific skipper 308-1 for a specific container 304-1 that is located in a specific harbor 302-1.

Checker 310-1, 310-2 verifies the user input against a set of results. The set of results is stored within each harbor 302 of the plurality of harbors 302. They are coded within a software component. The checker 310-1, 310-2 uses classic software logic, artificial intelligence algorithms, machine learning algorithms, or fuzzy logic to compare the user input with the set of results and generate an output.

Moreover, the output may be either a success or failure based on a match of the user input with the set of results. The output may be a set of instructions for the end user 202 if the output is neither successful nor a failure. Checker 310-1, 310-2 determine the set of instructions using the artificial intelligence algorithms and the set of results such that the end user 202 is guided towards successively completing the interactive queries. The set of instructions is performed on the virtual machine instance 120 through the computing task running environment.

The skipper 308-1, 308-2 checks the state or health of the harbor 302-1. The skipper 308-1, and 308-2 maintain a health check of the harbor 302-1 to monitor the functioning of the harbor 302-1. The harbor 302-1 functions to generate user specific computing task running environment for the end user 202. The computing task running environment is customized based on the interactive queries determined for the end user 202.

The customized computing task running environment includes presenting personalized interactive queries, and predetermined steps queries based on preferences, skills, experience, and qualification of the end user 202. The harbor 302-1 is monitored by the skippers 308 to communicate with containers 304-1, and 304-2. The generation of harbor 302-1 is checked against the user requirements. The state of harbor 302-1 is provided to harbor agent 306 for processing. The component in charge of executing a checker code on containers 304-1, and 304-2 is skipper 308-1, and 308-2 respectively.

For example, when the container management engine 112 receives a message from the computing task running environment 102, the message regarding task 2. The computing task running environment 102 would send the message saying, check task 2, an original folder would access this specific harbor 302-1 that the end user is assigned to check the status of task 2. The container management engine 112 and the skipper 308 control component on each harbor 302 and the skipper 308 check the user's input and provide the harbor agent 306 with the response. The skipper 308 executes the checker code that exists in the same container 304 that the end user is interacting with.

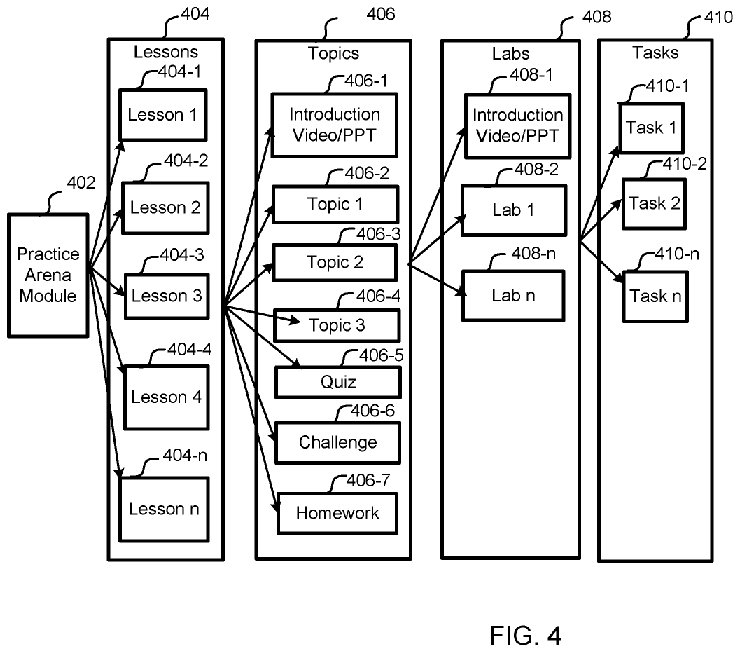

Referring next to FIG. 4, an embodiment of a interactive queries is shown. The interactive queries is a practice arena module 402 which is provided to the end user 202 on the computing task running environment via the interface 106. The interactive queries is user specific and/or tenant specific. The end user 202 undertakes the practice arena module 402 on the virtual machine instance 120. The practice arena module 402 includes a number of lessons 404 including lessons 404-1, 404-2, 404-3, 404-4, and 404-n. Each of the lessons 404 include a number of topics 406. Each of the lessons 404 including a plurality of labs is supported by a respective virtual machine instance 120.

Each lab within a topic that is within a lesson is supported by a respective virtual machine. Additionally, challenges that are contained within lessons are supported by virtual machines. The topics 406 include introduction/video/ppt 406-1, topics 406-2, 406-3, 406-3, quiz 406-5, challenge 406-6, and homework 406-7. Each topic 406 includes a plurality of labs 408 to be taken. Labs 408 includes introduction/video/ppt 408-1, lab 408-2, and lab 408-n. Each lab 408 includes a number of predetermined steps query 410 to be performed in order to complete lab 408. Task 410 may include a number of predetermined steps queries, for example, task 410-1, 410-2, and task 410-n.

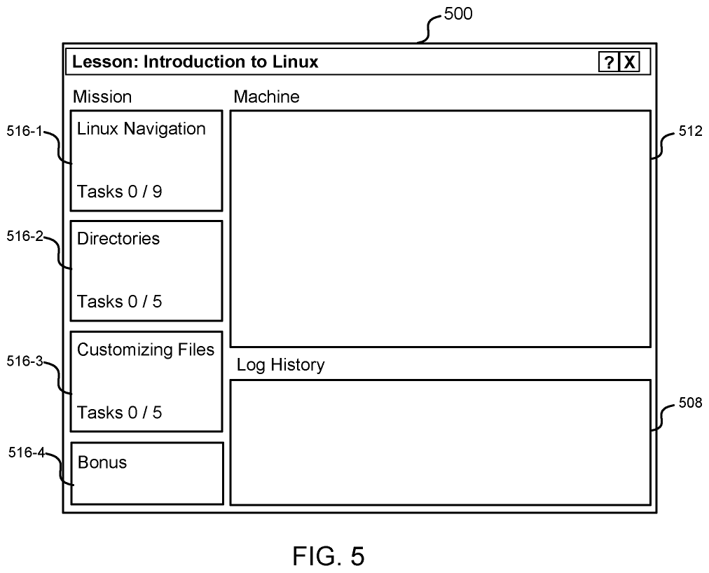

Referring next to FIG. 5, represents an exemplary embodiment of the interactive program presented to the end-user on the end-user device. FIG. 5 illustrates a Graphical User Interface (GUI) 500 of a lesson in the computing task running environment 102 presented to the end user 202 on the end user device 110 is shown. The GUI 500 includes missions 516-1 or interactive queries, The missions 516-1 linux navigation shows a task status including a number of predetermined steps queries completed out of a total number of predetermined steps queries for the actual lab missions (516-1, 516-2, 516-3) for example, 0/9. The 0/9 on the missions 516-1 means that you have completed 0/9 predetermined steps queries in this lab. Missions 516-4 may be a lab, or it may be PPT/Video or another lab. Directories 516-2 and customizing files 516-3 are other labs with display of the task status. Bonus 516-4 displays points or score on completing the missions.

In yet another embodiment of the present disclosure, machine 512 is the virtual machine instance 120 where the end-user 202 performs the missions. Log history 508 displays the log of predetermined steps queries completed by the end-user 202 or which are in progress.

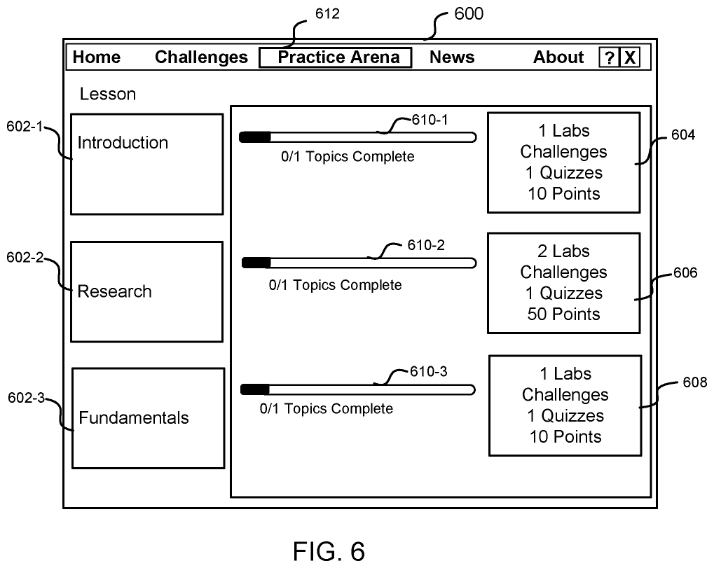

Referring next to FIG. 6, a Graphical User Interface (GUI) 600 of a practice arena 612 in the computing task running environment 102 presented on the interface 106 of the end user 202 is shown. The end user 202 selects a tab of the practice arena 612 for undertaking the lessons namely introduction 602-1, research 602-2, and fundamentals 602-3. Progress on completion of topics in the lessons is displayed as 610-1, 610-2, and 610-3. A number of labs, challenges, quizzes, and points of respective lessons are displayed in GUI 604, 606, and 608. The GUI 600 further includes the home, challenges, news, and about tabs for accessing webpages of the respective tabs.

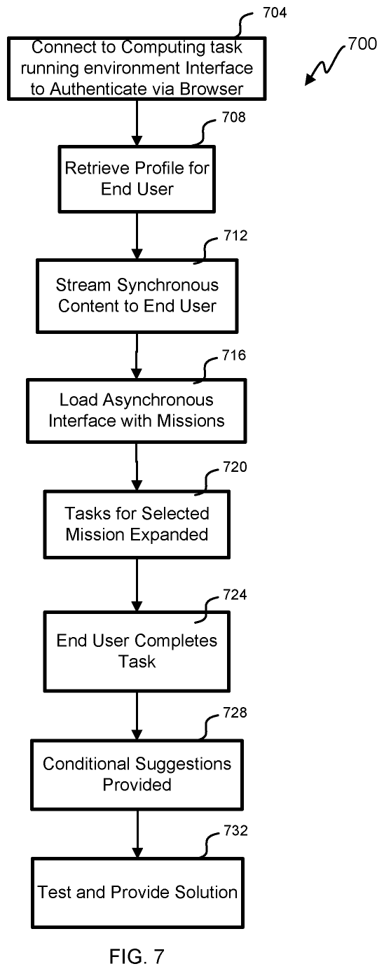

Referring next to FIG. 7, a flowchart of an embodiment of an interactive process 700 in the computing task running environment 102 is shown. The depicted portion of the process begins in block 704 where an end user 202 of an end user device 110 connects to the computing task running environment 102 using the interface 106. The end user 202 uses a web browser link to access the computing task running environment 102. Multiple tenants or enterprises may use the same network separated by domain or some other logical separation. The end user 202 is associated with a tenant from multiple tenants. The end user 202 may either create an account by providing user details or log into the computing task running environment 102 (if the account is already been created). The user details of the end user 202 are authenticated by the computing task running environment 102. Based on the authentication by the computing task running environment 102, the end user 202 may undertake a plurality of interactive queries. The interactive queries include predetermined steps queries (e.g. labs, missions/lessons, tasks, quizzes, and/or challenges).

At block 708, after the end user 202 is authenticated, a profile is retrieved for the end user 202. The profile is based on the user details provided by the end user 202. The user details are personal information provided by the end-user 202 that is unique to the end user 202. The end user 202 may also provide other users' details such as qualifications, skills, interests, experience, and/or details related to the interactive process. The profile includes a filtered set of interactive queries for the end user 202. The profile is generated by the computing task running environment 102 based on the user details.

At block 712, the computing task running environment 102 streams synchronous content to the end user 202 based on the profile of the end user 202. The end user 202 may select and get details of the plurality of interactive queries from the set of interactive queries. The synchronous content includes a plurality of interactive queries common to all the end users or tenants. The predetermined steps queries within the interactive queries are also common for all the end users.

At block 716, based on the profile of the end user 202, the tenant of the end user 202, and the plurality of selected interactive queries, asynchronous content specific to the end user 202 is loaded to the interface 106 of the end user 202 by the container management engine 112. The asynchronous content includes customized user specific interactive queries including a number of missions or lessons. The missions include predetermined steps queries of the interactive queries that are user and/or tenant specific. The user specific interactive queries are accessible to the end user 202 from a computing task running environment on interface 106 via a virtual machine instance 120 of the container management engine 112. Each of the labs has respective virtual machine instances 120.

In yet another embodiment of the present disclosure, the interactive queries are performed on the virtual machine instance 120. The end user 202 selects a plurality of interactive queries from the asynchronous content for interactive engagement and skill enhancement. A plurality of missions is selected by the end-user 202.

At block 720, predetermined steps queries associated with the plurality of selected missions are expanded for selection by the end user 202. The end user 202 undertakes one task at a time. The task is performed on the virtual machine instance 120 by providing user input. The user input may be provided using the input devices of the end user device 110.

At block 724, the end user 202 completes the task by providing the user input. The user input corresponding to the task is validated in the virtual machine instance 120 for output.

At block 728, the container management engine 112 generates a number of conditional suggestions for the end user 202 based on the user input. The conditional suggestions may include further instructions to perform the present task or proceed with the next task. The task may be successfully completed or may be a few steps away from success.

In yet another embodiment of the present disclosure, a success result is indicated to the end user 202 in the conditional suggestions if the task is successfully completed by the end user 202 else further instructions are provided until the task is successfully completed by the end-user 202. The user input is checked in the virtual machine instance 120 of the container management engine 112 and the conditional suggestions are generated after the check.

At block 732, the task is tested for completion and a solution is provided to the end user 202. The success result is communicated to the end user 202 on interface 106 and the solution is also displayed for reference.

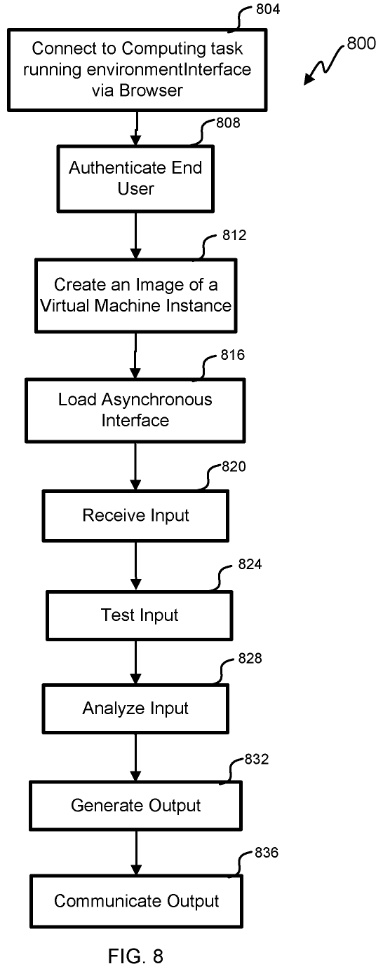

Referring next to FIG. 8, a flowchart of an embodiment of a checking process 800 of a functional test performed is shown. The depicted portion of the process begins in block 804 where an end user 202 of an end user device 110 connects to the computing task running environment 102 via a web browser using the interface 106 of the end user device 110. The end user 202 is associated with a tenant of a plurality of tenants or enterprises accessing the cloud-based multi-tenant environment.

At block 808, the end user 202 is authenticated by the computing task running environment 102. The end user 202 may either create an account by providing user credentials or log into the computing task running environment 102 if the account is previously created. Based on the authentication by the computing task running environment 102, the end user 202 may undertake a plurality of interactive queries. The interactive queries include predetermined steps queries. The end user 202 may refer to details of the interactive queries using the computing task running environment 102. User specific interactive queries are generated by the container management engine 112 for the end user 202 based on the user details. The interactive queries are presented to the end user 202 using interface 106.

At block 812, a virtual machine instance 120 is created for the end user 202 using an image of an instance of a virtual machine through which the end user 202 undertakes the plurality of interactive queries. The virtual machine instance 120 provides the computing task running environment for the end user 202. The image is deployed on the virtual machine instance 120. The interface 106 communicates directly with the environment within the VM instance 120 over the internet. The container management engine 112 passes inputs we wish to test for task solution.

At block 816, an asynchronous interface that is user specific is loaded using the virtual machine instance 120 for the end user 202. The asynchronous interface loads content that is either a lab or a challenge for the end user 202 based on the user qualification, skills, interests, experience, or requirements. The end user 202 may select a plurality of interactive queries with customized missions when the missions are labs. If the missions refer to predetermined steps queries, then every lab has its own predetermined steps queries, they're not customized. The missions include a plurality of predetermined steps queries.

At block 820, an input is received from the end user 202 as the end user 202 performs the plurality of predetermined steps queries. The input is provided using a user interface of the computing task running environment to the container management engine 112. The input is received by the virtual machine instance 120 from the container management engine 112. The harbor agent 306 of the virtual machine instance 120 receives the input and provides it to checker 310 of the virtual machine instance 120 for processing.

At block 824, the input is tested using a test button. As the end user 202 clicks on a test button on interface 106, the control passes the web browser, the computing task running environment 102, the container management engine 112, harbor agent 306, and then containers 304. At block 828, checker 310 of the virtual machine instance 120 analyzes the input received from the end user 202 and compares it with data in the appropriate harbor of the plurality of harbors 302-1, 302-2, 302-N. This is managed by the container management engine 102. The checker 310 includes a python script (not limited to python script) which is activated to perform a check on the input.

In yet another embodiment of the present disclosure, keywords are searched within user logs and the input. The keywords are compared and read from the appropriate harbor of the plurality of harbors 302-1, 302-2, 302-N to generate a result. The input is analyzed using machine learning (ML) algorithms. The ML algorithms are used to determine whether the input results in a final output or not and the steps to be taken or changes to be done in the input to reach the final output. The analyzed response/output allows the user to know whether or not they solved it correctly.

At block 832, an intermediate output is generated for the input entered by the end user 202. If the intermediate output is not a final output as indicated by the harbor 302-1, the steps to be taken to reach the final output are determined by the end user 202.

At block 836, the intermediate output whether it is the final output or the steps to be taken to reach the final output is communicated to the end user 202 using the harbor agent 306. The steps include a plurality of instructions to be performed by the end user 202. The steps are based on the input entered by the end user 202. The steps help the end user 202 learn the modules step by step as if the end-user 202 is trained in a real stimulated environment.

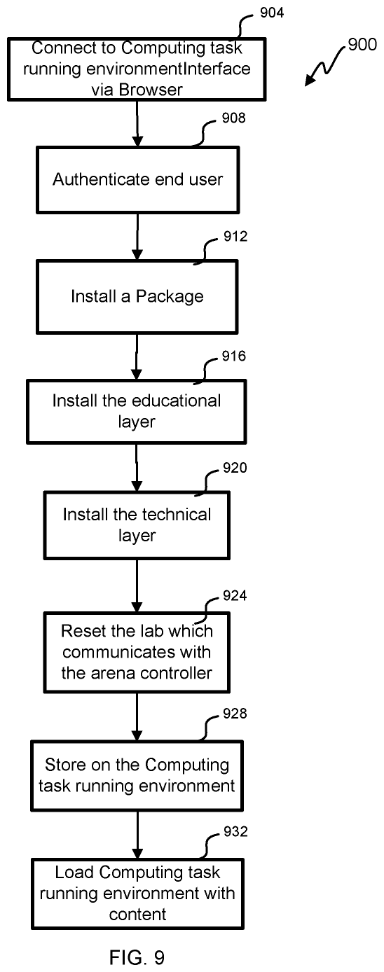

Referring next to FIG. 9, a flowchart of an embodiment of an installation process 900 for instantiating harbors for a computing task running environment is shown. The depicted portion of the process begins in block 904 where an end user 202 of an end user device 110 connects to a synchronous interface of the computing task running environment 102 via a web browser. The end user 202 is within a tenant or enterprise accessing the cloud-based multi-tenant environment.

At block 908, the end user 202 is authenticated by the computing task running environment 102 based on user credentials or user identifiers provided by the end user 202. At block 912, a package is installed. The package is parsed to install. The package includes configuration, port, operating system, and virtual machine entailed for creating the user specific computing task running environment for the end user 202. The package includes manifest files for creating the virtual resource container running model (e.g. isolated arena environment).

The manifest file includes metadata associated with the interactive queries. The metadata includes data associated with the predetermined steps queries. The package further includes a functionality implementing labs, links to a checker 310 of a harbor 302 of the virtual machine instance 120, and challenges. The package is used to create content describing scenarios and objectives for the labs, hints, and solutions generated in harbors 302. The package is a file encapsulating links to the content and implementing the functionality associated with the interactive process. The package contains services wrapped up as docker containers that are compiled upon installation, some services may be installed in an asynchronous process and support virtual machine image references.

At block 916, an educational layer of the package is installed. The pod package is a zip file that contains two layers, namely the educational layer and a technical layer. The technical layer needs to be installed and wrapped up with the educational layer which shows the solution for the task and the hint. In order to prevent any misappropriation by the end user 202, each virtual machine harbor has a limited compute or time slot and is tracked to charge back in case the limited time slot is over.

At block 920, the technical layer is installed on the container management engine 112. At block 924, the lab which communicates with the container management engine 112 are reset. The package is passed onto the container management engine 112 and then the container management engine 112 starts creating virtual machines and creating images. Basically, the package is passed from the computing task running environment 102 through the container management engine 112. It uses another component, namely the Image Builder to compile docker images.

At block 928, predetermined steps query finished is stored on the computing task running environment 102. The docker images are stored on an elastic container registry (ECR). The container management engine knows exactly which images to take from the elastic container registry. Link them together using the Amazon ECS technology and create an isolated environment.

At block 932, after the technical layer and the educational layer are installed, they are executed. When the actual content is desired to be accessed, the computing task running environment 102 is loaded with the content.

In yet another embodiment of the present disclosure, the method may include selecting a container management engine as a computing task running environment. The method may also include streaming synchronous content on a first interface of a user device of a plurality of user devices, where the synchronous content includes a set of interactive queries accessible on the plurality of user devices.

In yet another embodiment of the present disclosure, the method may furthermore include receiving a selection of an interactive program from the first interface based on the synchronous content. The method may in addition include designing a virtual resource container running model for the container management engine in response to the received selection. The method may moreover include creating a virtual machine instance based on the received selection, where. The method may also include received selection may include the selection of at least one interactive program.

Furthermore, the Method may include the virtual machine instance includes a plurality of harbors. The method may in addition include each harbor includes a plurality of containers, a harbor agent, a plurality of skippers and a plurality of checkers. Method may moreover include analyzing the selection received on an interface of the virtual machine instance using a plurality of checkers. Method may also include where the checkers are adapted to compare the selection received with a set of results stored within each harbor of the plurality of harbors using machine learning algorithms.

The method may furthermore include generating an output, using the machine learning algorithms, based on a match of the selection received with the set of results, where the output may include a result value and a set of instructions to be performed on the virtual machine instance. Other embodiments of this aspect include corresponding computer systems, apparatus, and computer programs recorded on a plurality of computer storage devices, each configured to perform the actions of the methods.

In yet another embodiment of the present disclosure, the container management engine is configured to create the virtual machine instance for each end user using images of instances of virtual machines. Also, the virtual machine instance is hosted on a cloud environment, and where each harbor includes a plurality of docker containers hosted on the cloud environment. The method may include determining the interactive program, via a plurality of harbors, based on a plurality of attributes associated with the user device, where the plurality of attributes includes a level of skills, user requirements, and/or educational background of an end user associated with the user device.

Furthermore, the method may include providing communication between the plurality of harbors and the user device via the harbor agent, receiving test inputs on the user device using the harbor agent, and providing the received selection from the user device to the harbor for processing via the container management engine.

In yet another embodiment of the present disclosure, the method may include: identifying an anomaly in the harbor based on periodically receiving a status check response from the plurality of skippers, and providing the identified anomaly to the container management engine for rectification. Method may include generating asynchronous content based on an user profile associated with the user device and performance associated with the user device. Implementations of the described techniques may include hardware, a method or process, or a computer tangible medium.

In yet another embodiment of the present disclosure, a container management engine as a computing task running environment, where the container management engine is configured to. System may also include stream synchronous content on a first interface of a user device of a plurality of user devices, where the synchronous content includes a set of interactive queries accessible on the plurality of user devices.

Furthermore, the system may include receiving a selection of an interactive program from the first interface based on the streamed synchronous content. The system may in addition include a virtual resource container running model for the container management engine in response to the received selection. The system may moreover include creating a virtual machine instance based on the received selection, where the system may also include the received selection may include a selection of at least one interactive program.

The system may furthermore include the virtual machine instance includes a plurality of harbors. The system may in addition include each harbor includes a plurality of containers, a harbor agent, a plurality of skippers, and a plurality of checkers. The system may moreover include analyzing of the selection received on an interface of the virtual machine instance using a plurality of checkers.

The system may also include where the checkers are adapted to compare the selection received with a set of results stored within each harbor of the plurality of harbors using machine learning algorithms. The system may furthermore include generating an output, using the machine learning algorithms, based on a match of the selection received with the set of results, where the output may include a result value and a set of instructions to be performed on the virtual machine instance. Other embodiments of this aspect include corresponding computer systems, apparatus, and computer programs recorded on a plurality of computer storage devices, each configured to perform the actions of the methods.

In yet another embodiment of the present disclosure, the container management engine is further configured to create the virtual machine instance for each end user using images of instances of virtual machines. System where the virtual machine instance is hosted on cloud environment and where each harbor includes a plurality of docker containers hosted on the cloud environment.

In yet another embodiment of the present disclosure, the container management engine is further configured to determine the interactive program, via a plurality of harbors, based on a plurality of attributes associated with the user device, where the plurality of attributes includes a level of skills, user requirements, and/or educational background of an end user associated with the user device.

In yet another embodiment of the present disclosure, the container management engine is further configured to: provide communication between the plurality of harbors and the user device via the harbor agent, test inputs received on the user device using the harbor agent and provide the received selection from the user device to the harbor for processing via the container management engine.

In yet another embodiment of the present disclosure, the system where the container management engine is further configured to: identify an anomaly in the harbor based on periodically receiving a status check the response from the plurality of skippers, and providing the identified anomaly to the container management engine for rectification.

In yet another embodiment of the present disclosure, the container management engine is further configured to generate asynchronous content based on a user profile associated with the user device and performance associated with the user device. Implementations of the described techniques may include hardware, a method or process, or a computer tangible medium.

In yet another embodiment of the present disclosure,—computer-readable storage medium may include selecting a container management engine as a computing task running environment. A computer-readable storage medium may also include streaming synchronous content on a first interface of a user device of a plurality of user devices, where the synchronous content includes a set of interactive queries accessible on the plurality of user devices.

In yet another embodiment of the present disclosure, the medium may furthermore include receiving a selection of an interactive program from the first interface based on the synchronous content. The medium may in addition include designing a virtual resource container running model for the container management engine in response to the received selection. The medium may moreover include creating a virtual machine instance based on the received selection, where:. Medium may also include received selection may include selection of at least one interactive program.

The medium may furthermore include the virtual machine instance includes a plurality of harbors. The medium may in addition include each harbor includes a plurality of containers, a harbor agent, a plurality of skippers and a plurality of checkers. The medium may moreover include analyzing the selection received on an interface of the virtual machine instance using a plurality of checkers. Medium may also include where the checkers are adapted to compare the selection received with a set of results stored within each harbor of the plurality of harbors using machine learning algorithms.

The medium may furthermore include generating an output, using the machine learning algorithms, based on a match of the selection received with the set of results, where the output may include a result value and a set of instructions to be performed on the virtual machine instance. Other embodiments of this aspect include corresponding computer systems, apparatus, and computer programs recorded on a plurality of computer storage devices, each configured to perform the actions of the methods.

In yet another embodiment of the present disclosure, the interactive program includes an assessment component, a certification component, a progress tracking component, a gamification component. Also, the interactive queries are customizable either by the user or automatically customized based on the user profiles.

In yet another embodiment of the present disclosure, the asynchronous content is updated in real-time. Also, the user input is analyzed in real-time and the output is provided to the user in real-time.

In yet another embodiment of the present disclosure, the interactive program is selected based on the user's role within an organization. Furthermore, the interactive program is selected based on the user's previous interactive engagement history.

In yet another embodiment of the present disclosure, the interactive program is selected based on the user's goals. Moreover, the interactive program is selected based on the user's skill level.

In yet another embodiment of the present disclosure, the method may include configuring a first interface on a user device of a plurality of user devices based on authentication of the user device. Method may also include streaming synchronous content on the first interface of the user device, where the synchronous content includes a set of interactive queries accessible on the plurality of user devices. Method may furthermore include receiving a selection of a interactive program from the first interface based on the streamed synchronous content.

Method may in addition include providing a plurality of virtual machine instances on a cloud environment to enable the user device to access an virtual resource container running model, where: the virtual resource container running model is user specific and/or tenant specific, the virtual resource container running model includes the interactive program delivered using a second interface of the user device, and the interactive program includes interactive queries having predetermined steps queries.

The method may moreover include streaming asynchronous content via the virtual resource container running model on the interface of the user device, where the asynchronous content includes interactive queries, associated with the user profiles, accessible on the user device. Method may also include receiving an input with respect to the interactive program from the interface run on a virtual machine instance of the plurality of virtual machine instances. The method may furthermore include generating an output based on an analysis of the received input. The method may in addition include communicating the output to the user device on the interface.

Other embodiments of this aspect include corresponding computer systems, apparatus, and computer programs recorded on a plurality of computer storage devices, each configured to perform the actions of the methods.

In yet another embodiment of the present disclosure, the checker of the virtual machine instance uses artificial intelligence algorithms to analyze the input and generate the output, and the output includes a result and/or a plurality of operations to be performed on the virtual machine instance.

Method where the plurality of operations includes a series of interactive engagement steps performed as a simulation in the virtual resource container running model, and where the virtual resource container running model is created based on a container technology. Method where the virtual resource container running model is accessed using a web browser.

Method where each virtual machine instance of the plurality of virtual machine instances includes a plurality of harbors, the plurality of harbors are isolated from each other and communicate with an interactive engagement controller through a harbor agent, each of the harbors include a plurality of skippers, a plurality of containers, the harbor agent, and a plurality of checkers, a state of a harbor of the plurality of harbors is monitored by the plurality of skippers, the plurality of checkers determines the output of the interactive program, and the output is communicated to the interface via the harbor agent based on the state of the harbor of the plurality of harbors.

In one method, the plurality of virtual machine instances are selected from a pool of virtual machine instances on the cloud environment. The method may include: a checker of the virtual machine instance that determines the output of the functional test using artificial intelligence algorithms. Method where: the virtual machine instance includes a plurality of harbors, each of the plurality of harbors includes a plurality of skippers, a plurality of containers, the harbor agent, and a plurality of checkers, a state of a harbor of the plurality of harbors of the virtual machine instance is determined using the plurality of skippers, the state of the plurality of harbors includes the state of functionality of the plurality of harbors, the plurality of harbors include servers, and databases, the output is based on the state of the plurality of harbors, and the output is communicated to the interface of the user device based on the state of the harbor of the plurality of harbors.

Method where the interactive program includes at least one assessment component, a certification component, a progress tracking component, and a gamification component, and where the interactive program is selected based on at least one of the tenant's previous interactive engagement history goals, or skill level.

The method may include at least one of updating the asynchronous content in real-time, analyzing the user input in real-time, and providing the output to the user device in real-time. Implementations of the described techniques may include hardware, a method or process, or a computer tangible medium.

In yet another embodiment of the present disclosure, providing a plurality of virtual machine instances on a cloud environment to enable a user device of a plurality of user devices to access the virtual resource container running model based on authentication of the user device. The method may also include facilitating the user device that is within a plurality of tenants to access the virtual resource container running the model using the virtual machine instance, where: the virtual resource container running model is user specific and/or tenant specific, the virtual resource container running model presents the functional test to be performed on the user device, and the functional test includes interactive queries (e.g. learning modules) having predetermined steps queries.

The method may furthermore include receiving an input with respect to the functional test from an interface run on the virtual machine instance. The method may in addition include analyzing the input to generate an output of the functional test (e.g. training test) to ensure that individual units of predetermined steps queries are working correctly and meet the desired specifications.

The method may moreover include generating the output based on the analysis, where: the output includes a plurality of instructions for the user device, and the plurality of instructions to be performed on the virtual machine instance based on the plurality of instructions. The method may also include communicating the output to the user device. Other embodiments of this aspect include corresponding computer systems, apparatus, and computer programs recorded on a plurality of computer storage devices, each configured to perform the actions of the methods.

In yet another embodiment of the present disclosure, receiving a package of a plurality of packages, where each package of the plurality of packages specifies a virtual machine harbor and applications running thereon, the package defines a configuration of the virtual resource container running model. The method may also include parsing the package, in order to use the plurality of virtual machine harbors to access the virtual resource container running the model on a user device of a plurality of user devices with a plurality of tenants, where: the virtual resource container running model is user specific and tenant specific, the virtual resource container running model includes a test of the interactive engagement process for the user device, the test includes labs, and/or modules, and the package includes an educational layer wrapped in a technical layer.

The method may furthermore include loading an application on the user device to access the virtual resource container running model to undertake the test of the interactive engagement process. Other embodiments of this aspect include corresponding computer systems, apparatus, and computer programs recorded on a plurality of computer storage devices, each configured to perform the actions of the methods.

In yet another embodiment of the present disclosure, the plurality of virtual machine harbors include a checker and a harbor agent, the checker generates the output of the test using artificial intelligence algorithms, and the output is communicated to an interface of the user device via the harbor agent. The method where the virtual resource container running model is accessed using a web browser.

In yet another embodiment of the present disclosure, the package includes a manifest file for creation of the virtual resource container running model for the plurality of user devices of the plurality of tenants, the manifest file includes metadata associated with the interactive engagement process, the metadata includes data associated with the predetermined steps queries of the test, a functionality implements labs, links to a checker of the virtual machine harbor, and challenges and content includes scenarios and objectives for the labs, hints, solutions. The method the package is a file encapsulating links to the content and implementing the functionality associated with the interactive engagement process.

In yet another embodiment of the present disclosure, a unique identifier is used for accessing the virtual resource container running model (e.g. isolated training environment) on the user device. Method where each virtual machine harbor has limited computing and is tracked to chargeback. Method where the package contains services wrapped up as docker containers that are compiled upon installation.

In yet another embodiment of the present disclosure, the plurality of virtual machine harbors includes a plurality of skippers and a plurality of containers, a state of the plurality of containers is determined using the plurality of skippers, the state of the plurality of containers is a functionality associated with the plurality of containers. Method the package defines a interactive engagement configuration including a virtual machine, an operating system, and/or ports. Implementations of the described techniques may include hardware, a method or process, or a computer tangible medium.

A system of a plurality of computers can be configured to perform particular operations or actions by virtue of having software, firmware, hardware, or a combination of them installed on the system that in operation causes or cause the system to perform the actions. A plurality of computer programs can be configured to perform particular operations or actions by virtue of including instructions that, when executed by data processing apparatus, cause the apparatus to perform the actions.

A number of variations and modifications of the disclosed embodiments can also be used. Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within a plurality of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary predetermined steps queries may be stored in a machine readable medium such as a storage medium.

Additionally, a code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, non-volatile, or other storage medium and is not to be limited to any particular type of memory or number of memories, or type of media upon which memory is stored.

Moreover, as disclosed herein, the term “storage medium” may represent a plurality of memories for storing data, including read only memory (ROM), random access memory (RAM), magnetic RAM, core memory, magnetic disk storage mediums, optical storage mediums, flash memory devices and/or other machine-readable mediums for storing information. The term “machine-readable medium” includes but is not limited to portable or fixed storage devices, optical storage devices, and/or various other storage mediums capable of storing that contain or carry instruction(s) and/or data.

While the principles of the disclosure have been described above in connection with specific apparatuses and methods, it is to be clearly understood that this description is made only by way of example and not as limitation on the scope of the disclosure.

What is claimed is:

1. A method of virtual resource container running model for asynchronous content delivery using a container management engine, comprising:
selecting a container management engine as a computing task running environment;
streaming synchronous content on a first interface of a user device of a plurality of user devices, wherein the synchronous content includes a set of interactive queries accessible on the plurality of user devices;
receiving a selection of an interactive program from the first interface based on the synchronous content;
designing a virtual resource container running model for the container management engine in response to the received selection;
creating a virtual machine instance based on the received selection, wherein:
received selection comprises selection of at least one interactive program,
the virtual machine instance includes a plurality of harbors;
each harbor includes a plurality of containers, a harbor agent, a plurality of skippers and a plurality of checkers;
analyzing the selection received on an interface of the virtual machine instance using a plurality of checkers;
wherein the checkers are adapted to compare the selection received with a set of results stored within each harbor of the plurality of harbors using machine learning algorithms; and
generating an output, using the machine learning algorithms, based on a match of the selection received with the set of results, wherein the output comprises a result value and a set of instructions to be performed on the virtual machine instance.

2. The method of claim 1, wherein the container management engine is configured to create the virtual machine instance for each end user using images of instances of virtual machines.

3. The method of claim 1, wherein the virtual machine instance is hosted on cloud environment and wherein each harbor includes a plurality of docker containers hosted on the cloud environment.

4. The method of claim 1, further comprising determining the interactive program, via a plurality of harbors, based on a plurality of attributes associated with the user device, wherein the plurality of attributes includes a level of skills, and/or educational background of an end user associated with the user device.

5. The method of claim 1, further comprising:
providing communication between the plurality of harbors and the user device via the harbor agent;
receiving test inputs on the user device using the harbor agent; and
providing the received selection from the user device to the harbor for processing via the container management engine.

6. The method of claim 1, further comprising:
identifying an anomaly in the harbor based on periodically receiving a status check response from the plurality of skippers; and
providing the identified anomaly to the container management engine for rectification.

7. The method of claim 1, further comprising generating asynchronous content based on a user profile associated with the user device and performance associated with the user device.

8. A system of virtual resource container running model for asynchronous content delivery using a container management engine, comprising:
a container management engine as a computing task running environment, wherein the container management engine is configured to:
stream synchronous content on a first interface of a user device of a plurality of user devices, where the synchronous content includes a set of interactive queries accessible on the plurality of user devices;
receive a selection of an interactive program from the first interface based on the streamed synchronous content;
a virtual resource container running model for the container management engine in response to the received selection;
create a virtual machine instance based on the received selection, wherein:
the received selection comprises selection of at least one interactive program, the virtual machine instance includes a plurality of harbors;
each harbor includes a plurality of containers, a harbor agent, a plurality of skippers and a plurality of checkers;
analyze the selection received on an interface of the virtual machine instance using a plurality of checkers;
wherein the checkers are adapted to compare the selection received with a set of results stored within each harbor of the plurality of harbors using machine learning algorithms; and
generate an output, using the machine learning algorithms, based on a match of the selection received with the set of results, where the output comprises a result value and a set of instructions to be performed on the virtual machine instance.

9. The system according to claim 8, wherein the container management engine is further configured to create the virtual machine instance for each end user using images of instances of virtual machines.

10. The system according to claim 8, wherein the virtual machine instance is hosted on cloud environment and wherein each harbor includes a plurality of docker containers hosted on the cloud environment.

11. The system according to claim 8, wherein the container management engine is further configured to determine the interactive program, via a plurality of harbors, based on a plurality of attributes associated with the user device, wherein the plurality of attributes includes a level of skills, and/or educational background of an end user associated with the user device.

12. The system according to claim 8, wherein the container management engine is further configured to:
provide communication between the plurality of harbors and the user device via the harbor agent;
test inputs received on the user device using the harbor agent; and
provide the received selection from the user device to the harbor for processing via the container management engine.

13. The system according to claim 8, wherein the container management engine is further configured to:
identify an anomaly in the harbor based on periodically receiving a status check response from the plurality of skippers; and
provide the identified anomaly to the container management engine for rectification.

14. The system according to claim 8, wherein the container management engine is further configured to generate asynchronous content based on a user profile associated with the user device and performance associated with the user device.

15. A computer-readable storage medium storing instructions that, when executed by a computer, perform a method of virtual resource container running model for asynchronous content delivery using a container management engine, comprising:
selecting a container management engine as a computing task running environment;
streaming synchronous content on a first interface of a user device of a plurality of user devices, wherein the synchronous content includes a set of interactive queries accessible on the plurality of user devices;
receiving a selection of an interactive program from the first interface based on the synchronous content;
designing a virtual resource container running model for the container management engine in response to the received selection;
creating a virtual machine instance based on the received selection, wherein:
received selection comprises selection of at least one interactive program,
the virtual machine instance includes a plurality of harbors;
each harbor includes a plurality of containers, a harbor agent, a plurality of skippers and a plurality of checkers;
analyzing the selection received on an interface of the virtual machine instance using a plurality of checkers;
wherein the checkers are adapted to compare the selection received with a set of results stored within each harbor of the plurality of harbors using machine learning algorithms; and
generating an output, using the machine learning algorithms, based on a match of the selection received with the set of results, wherein the output comprises a result value and a set of instructions to be performed on the virtual machine instance.

16. The method of claim 15, wherein the container management engine is configured to create the virtual machine instance for each end user using images of instances of virtual machines.

17. The method of claim 15, wherein the virtual machine instance is hosted on cloud environment and wherein each harbor includes a plurality of docker containers hosted on the cloud environment.

18. The method of claim 15, further comprising determining the interactive program, via a plurality of harbors, based on a plurality of attributes associated with the user device, wherein the plurality of attributes includes a level of skills, and/or educational background of an end user associated with the user device.

19. The method of claim 15, further comprising:
providing communication between the plurality of harbors and the user device via the harbor agent;
receiving test inputs on the user device using the harbor agent; and
providing the received selection from the user device to the harbor for processing via the container management engine.

20. The method of claim 15, further comprising:
identifying an anomaly in the harbor based on periodically receiving a status check response from the plurality of skippers; and
providing the identified anomaly to the container management engine for rectification.
